(19) United States
(12) Patent Application Publication
(10) Pub. No.: US 2008/0017441 A1
(43) Pub. Date: Jan. 24, 2008

(54) Sound-deadening louver

(75) Inventors: Shoichi Takeda, Chikuma-shi (JP); Yukito Obinata, Nagano-shi (JP); Tsuyoshi Arai, Nagano-shi (JP)

Correspondence Address: STAAS & HALSEY LLP, SUITE 700, 1201 NEW YORK AVENUE, N.W., WASHINGTON, DC, 20005, US

(73) Assignee: MK SEIKO CO., LTD., Nagano-ken (JP)

(21) Appl. No.: 11/808,749

(22) Filed: Jun. 12, 2007

(30) Foreign Application Priority Data
Jul. 21, 2006 (JP) 199639/2006

(51) Int. Cl. F16F 15/00

(52) U.S. Cl. 181/207

(57) ABSTRACT

A sound-deadening louver is attached to vents that are formed in a wall structure. The louver is composed of a plurality of blades that are inclined at an angle to the surface of the wall structure. Each blade has a sound-deadening chamber therein, and an opening is formed on that side which faces each vent in the wall structure. First reflecting plates and second reflecting plates are mounted in the blade so as to extend from an edge portion of the opening into the sound-deadening chamber. The first reflecting plates have a curved shape, while the second reflecting plates have a flat shape.

### BACKGROUND OF THE INVENTION

1. Field of the Invention

The present invention relates to a sound-deadening louver provided on one surface of a wall structure of a building, such as a house, office, or factory, and configured to receive and reduce noise waves having passed through an opening in the wall structure.

2. Description of the Related Art

Soundproof walls are generally known as means for protection against noises that are generated from automobiles, construction fields, and other noise sources. These soundproof walls include wall structures that are formed of light-transmitting resin plates or metal members and set up beside roads or around construction fields. Each wall structure serves to prevent noises that are generated on one side thereof from being transmitted directly to the other side. The taller the soundproof walls, the higher the sound insulation effect is.

The noise sources include machines, such as industrial machines and outdoor units of air conditioners fixedly set in buildings, as well as the roads and construction fields. Many of these noise sources require secure ventilation or exhaust performance for the open air and radiation of heat that is generated as they (machines) are operated. If a machine (noise source) is entirely covered by a wall structure for sound insulation, however, the heat generated by the machine cannot be radiated, although a good sound insulation effect can be obtained. Thus, both a sound insulation effect and a ventilation effect can be obtained by using a louver having a soundproof wall structure with vents, wherein a machine is covered by the sound proof wall structure and a plurality of blades are attached to the vents like Venetian doors in a direction oblique to the wall surface.

An example of a soundproof louver that ensures both the sound insulation and ventilation effects is disclosed in Japanese Patent Application Laid-Open No. 60-223587 (JP 60-223587A). This louver is designed so that noises in a building can be prevented from leaking out without increasing airflow resistance. The soundproof louver has a plurality of sound insulation plates, which are arranged at regular intervals so as to be individually swingable, and is attached to a communicating opening of a wall structure, door, duct, etc. Normally, the sound insulation plates of this soundproof louver swing in a direction to close the communicating opening, thereby preventing noises from a noise source in the building from leaking to the outside. If a wind blows into the building at a predetermined or higher rate, however, the sound insulation plates are swung open by the resistance of the wind, whereupon the open air is fed into the building through the communicating opening.

According to the soundproof louver described in the aforesaid patent document (JP 60-223587A), the sound insulation plates are closed by their own weight when there is no flow of the wind, so that the noises in the building can be prevented from leaking out. If the wind flows, however, the sound insulation plates are inevitably opened by a wind pressure to secure ventilation. Thus, the noises in the building leaks to the outside, so that the sound insulation effect cannot be fully exhibited.

### SUMMARY OF THE INVENTION

To solve the above problems of the prior art technique, it is an object of the present invention to provide a sound-deadening louver in which a plurality of blades are adapted to be mounted like Venetian doors along edge portions of vents in a wall structure or the like, thereby enjoying sound insulation performance without failing to secure ventilation performance.

In order to achieve the above object, in the sound-deadening louver of the present invention, each of blade which constitute the sound-deadening louver comprises: a body casing having a space of a predetermined capacity therein; a sound-deadening chamber in which a sound-absorbing material is provided to the inner wall of the body casing; an opening formed in the body casing at the side facing one of the vents; a first reflecting plate which is formed of a plate member having a cross section of curved profile and extends laterally from the edge of the opening into the sound-deadening chamber; and a second reflecting plate which is formed of a plate member having a cross section of flat profile, faces a curved surface of the first reflecting plate, and extends inward from the edge portion of the opening into the sound-deadening chamber. And noise waves which passed through the vents are introduced into the sound-deadening chamber through the first and second reflecting plates attached to the openings of the blades and are repeatedly reflected in the sound-deadening chamber, whereby sound pressure is lowered.

In the sound-deadening louver according to the present invention constructed in this manner, the noise waves which are generated from the noise source and then pass through the vents can be captured by the opening of the body casing of each blade that constitutes the sound-deadening louver. In particular, noise waves, which passed through the vents in the wall structure, are directly hit against the first reflecting plate and reflected thereby, moving toward sound wave inlets, from which the noise waves are guided into the sound-deadening chamber. Further, noise waves, which passed through the vents in the wall structure, are directly hit against the opening of the body casing and are diffracted at diffraction edges of a sound wave introduction plate, thereby moving along the surface of the sound wave introduction plate toward the sound wave inlets, from which the noise waves are guided into the sound-deadening chamber. Thus, the sound-deadening louver according to the invention can efficiently capture noise waves, so that it can enjoy a high sound-deadening effect as well as ventilation performance.

### BRIEF DESCRIPTION OF THE DRAWINGS

FIG. 1 is a perspective view showing one embodiment of a sound-deadening louver according to the present invention; and

FIG. 2 is a sectional view showing principal parts of the sound-deadening louver of FIG. 1.

### DETAILED DESCRIPTION OF THE PREFERRED EMBODIMENTS

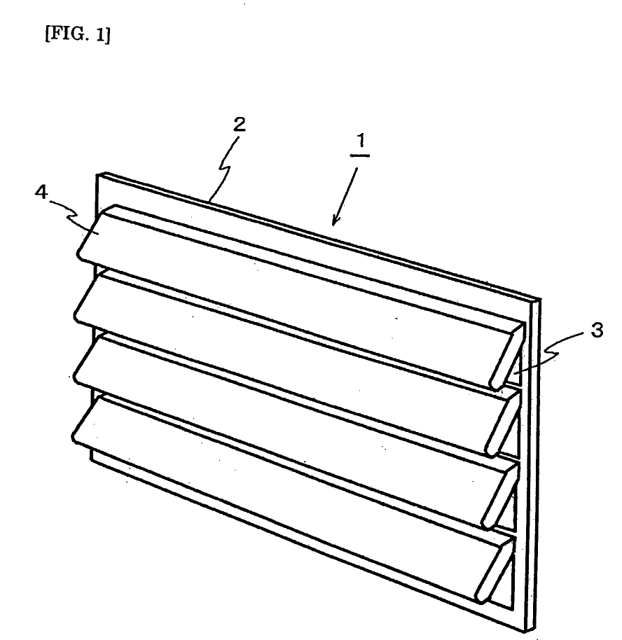

FIG. 1 shows an external appearance of one embodiment of a sound-deadening louver according to the present invention. As shown in FIG. 1, a sound-deadening louver 1 comprises a frame body 2, a plurality of vents 3 formed in the frame body 2, and a plurality of blades 4 attached like Venetian doors to the frame body 2 so as to cover the vents 3, individually.

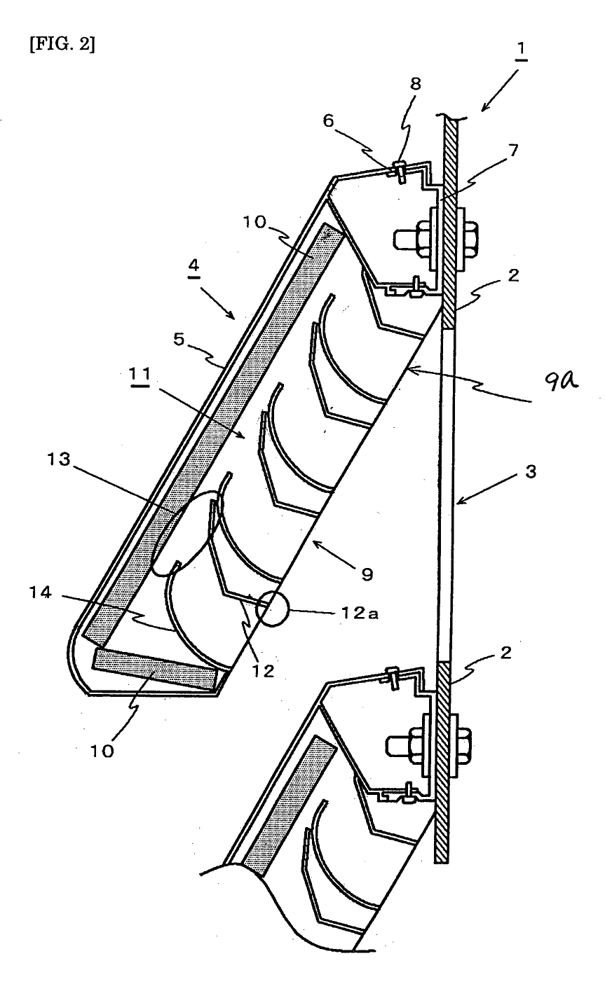

FIG. 2 is a sectional view showing principal parts (blades in particular) of the sound-deadening louver 1 shown in FIG. 1. As shown in FIG. 2, the blades 4 are arranged like Venetian doors on one side of the frame body 2, which is formed with the vents 3, so as to be able to close the vents 3. As shown in FIG. 1, each blade 4 is constructed so as to extend in the horizontal direction and is attached to the frame body 2 in a manner such that it is inclined with its frame-side end upward.

Since each vent 3 is closed by any one of the plurality of blades 4 that are arranged like Venetian doors, it cannot be visually penetrated from one side of the frame body 2 to the other. Thus, the presence of the blades 4 prevents formation of a horizontal through passage for air that penetrates the vents 3. Since a gap is formed between each two adjacent blades 4, however, air can windingly flow from the one side of the frame body 2 to the other by passing through the gap between the blades 4 and the vent 3.

The construction of each blade 4 will now be described with reference to the sectional view of FIG. 2. The blade 4 is provided with a body casing 5. The body casing 5 is formed of a metallic material and has a hollow housing structure that defines therein a space of a predetermined capacity. Each of the blades 4 that constitute the sound-deadening louver 1 is fixed to a bracket 7, which is attached to the frame body 2, by screwing screws 8 individually into mounting holes 6 in the body casing 5.

An opening 9 is provided in the body casing 5 on the side facing the vent 3 in the frame body 2. Thus, the internal space of the hollow housing that constitutes the body casing 5 communicates with the outside through the opening 9.

A sound absorber 10 that is formed of a fibrous or porous material, such as glass wool or rock wool, is stuck on the inner wall surface of the hollow housing of the body casing 5. Thus, the hollow housing portion forms a sound-deadening chamber 11. Noise waves, which are generated from a noise source (not shown) on the side of the frame body 2 opposite the location of the blades 4, are introduced into the sound-deadening chamber 11 through the vent 3 in the frame body 2 and the opening 9 of the body casing 5. Thereupon, nose energy is lowered in the chamber 11.

The body casing 5 is provided with sound wave introduction plates (or second reflecting plates) 12, which extend from an edge portion 9a of the opening 9 into the sound-deadening chamber 11. The noise waves generated from the noise source are delivered through the vent 3 to the side on which the blade 4 is mounted, and are diffracted at the diffraction edges 12a of the sound wave introduction plates 12. After that, the noise waves move along the surfaces of the sound wave introduction plates 12 toward sound wave inlets 13, where the noise waves are guided into the sound-deadening chamber 11.

The body casing 5 is further provided with reflecting plates (or first reflecting plates) 14, which face the surfaces of the sound wave introduction plates 12 and extend from the edge portion 9a of the opening 9 into the sound-deadening chamber 11. The noise waves pass through the vent 3 and are directly hit against the reflecting plates 14, where the noise waves are reflected. Then, they move toward sound wave inlets 13 and are then guided into the sound-deadening chamber 11. Further, those sound waves which have failed to be captured by diffraction at the diffraction edges 12a of the sound wave introduction plates 12 are reflected by the reflecting plates 14 and guided into the sound-deadening chamber 11.

Each reflecting plate (or first reflecting plate) 14 is formed of one plate member having a curved surface, and its sectional shape is a part of an ellipse. Each sound wave introduction plate 12 is positioned based on two focal positions of the elliptic profile of the reflecting plate 14. Each introduction plate (or second reflecting plate) 12 is formed by bending one flat plate member at one or more spots, and its sectional shape is defined not by a curved line but by one or more straight lines which are connected to each other. More specifically, a first end portion (or the diffraction edge 12a) and a second end portion (or the sound wave inlet 13) of each sound wave introduction plate 12 are situated on first and second focuses, respectively, of the elliptic profile of the reflecting plate 14.

The following is a description of the operation of the sound-deadening louver shown in FIG. 2. When the noise waves, which are generated from the noise source and pass through the vent 3 of the frame body 2, reach the opening 9, part of them are diffracted at the diffraction edges 12a of the sound wave introduction plates 12 and are guided along the surfaces of the introduction plates 12 into the sound-deadening chamber 11 through the sound wave inlets 13.

On the other hand, noise waves which are directly hit against the reflecting plates 14 are reflected by this reflecting plates 14 as they move along the plates 14 toward the sound wave inlets 13 and are guided into the sound-deadening chamber 11.

The noise waves, which pass through the opening 9 of the body casing 5 and are introduced into the sound-deadening chamber 11 through the sound wave inlets 13, repeat irregular reflection in the sound-deadening chamber 11. In consequence, the energy of such noise waves are mutually cancelled due to their reflection or lowered by dint of the sound absorber 10. Thus, the energy of the noise waves can be considerably reduced so that a sound-deadening effect is obtained. Naturally, the blades 4 cannot capture all the sound waves that are radiated through the vents 3, and the noise waves which failed to be captured leak into areas to be soundproofed. Since the energy of noise released from the noise source is considerably lowered, however, the sound-deadening effect can be obtained satisfactorily.

The present invention is not limited to the contents shown in FIGS. 1 and 2 and specifically described in connection with the foregoing embodiment, but various modifications and improvements may be possible as long as the essence of the present invention is not changed. For example, the sound wave introduction plates 12 and the reflecting plates 14 that are attached to the opening 9 of the body casing 5 may be of any other numbers than the ones shown in FIG. 2. Although the sectional shape of each reflecting plate 14 according to the foregoing embodiment is based on an elliptic curve, it may alternatively be based on a parabola, hyperbola, or any other curve. In this case, it is necessary only that focuses be aligned with the positions of the sound wave inlets 13.

What is claimed is:

1. A sound-deadening louver having a plurality of blades which are adapted to be mounted like Venetian doors along edge portions of vents in a wall structure or the like, each of those blades comprising:
a body casing having a space of a predetermined capacity therein;
a sound-deadening chamber in which a sound-absorbing material is provided to the inner wall of the body casing;
an opening formed in the body casing at the side facing one of the vents;
a first reflecting plate which is formed of a plate member having a cross section of curved profile and extends laterally from the edge of the opening into the sound-deadening chamber; and
a second reflecting plate which is formed of a plate member having a cross section of flat profile, faces a curved surface of the first reflecting plate, and extends inward from the edge portion of the opening into the sound-deadening chamber; wherein
noise waves which passed through the vents are introduced into the sound-deadening chamber through the first and second reflecting plates attached to the openings of the blades and are repeatedly reflected in the sound-deadening chamber, whereby sound pressure is lowered.
